(19) United States
(12) Patent Application Publication
(10) Pub. No.: US 2017/0312764 A1
(43) Pub. Date: Nov. 2, 2017

(54) ANTI-EXTRUSION HYDROCYCLONE

(71) Applicant: VEOLIA WATER SOLUTIONS & TECHNOLOGIES SUPPORT, SAINT-MAURICE CEDEX (FR)

(72) Inventors: Jacques ROBERT, Auvers Sur Oise (FR); Thomas THOUVENOT, Maisons Laffitte (FR); Nathalie VIGNERON-LAROSA, Paris (FR)

(73) Assignee: VEOLIA WATER SOLUTIONS & TECHNOLOGIES SUPPORT, SAINT-MAURICE CEDEX (FR)

(21) Appl. No.: 15/531,023

(22) PCT Filed: Nov. 27, 2015
(86) PCT No.: PCT/EP2015/077967

§ 371 Date: May 26, 2017

(30) Foreign Application Priority Data
Nov. 28, 2014 (FR) 1461630

(51) Int. Cl. B04C 5/14; B04C 5/13; B04C 5/04

(52) U.S. Cl. CPC B04C 5/14; B04C 5/04; B04C 5/13

(57) ABSTRACT

The present invention relates to a hydrocyclone which includes: a body (10) defining a hollow inner recess (11), said hollow inner recess (11) having an upper portion having a cylindrical cross-section (110) extended by a lower portion having a frusto-conical cross-section (111), the diameter of said frusto-conical cross-section (111) decreasing towards the lower portion of said body (10); an intake (12) for a mixture of liquid and solids leading into said cylindrical portion (110); an underflow outlet (13), for discharging said solids essentially separated from said liquid, wherein said underflow outlet is in communication with the lower end of said inner recess (11); an overflow outlet (15), for discharging said liquid essentially separated from said solids, wherein said overflow outlet is in communication with the upper end of said inner recess (11). Said overflow outlet (13) extends from the lower end of said lower portion having a frusto-conical cross-section (111) and has a frusto-conical cross-section, the diameter of which increases towards the lower portion of said hydrocyclone.

### 1. FIELD OF THE INVENTION

The field of the invention is that of the designing and manufacture of hydrocyclones conventionally used in the effluent treatment sector to separate the liquid phase and the solid phase of a mixture.

### 2. PRIOR ART

Hydrocyclones are commonly used during the treatment of certain effluents in order to carry out a liquid-solid separation.

The present Applicant uses hydrocyclones when implementing for example its water-treatment process commercially distributed under the name Actiflo®. These very same hydrocyclones are used in other methods for treating water or industrial effluents.

A water treatment method of the Actiflo® type comprises a step of ballasted flocculation during which the preliminarily coagulated and/or flocculated water is put into contact with ballast such as microsand in order to speedily cause the flocs that it contains to settle during a subsequent settling or sedimentation step.

This settling step leads to the production of at least partially treated water and a mixture of settled sludges and ballast.

To maintain the performance levels of such a treatment method, the ballast concentration must be kept essentially constant during the treatment.

To maintain performance levels while restricting ballast consumption and thus reducing operating costs, the ballast is recycled during treatment. To this end, the mixture of sludges and ballast is conveyed towards a hydrocyclone within which the solid phase formed by ballast is essentially separated from the liquid phase.

The mixture of liquid, sludges and ballast is introduced under pressure laterally into the body of the hydrocyclone which has an internal cylindrical-truncated cone shape, the diameter of which diminishes towards the underflow part of the cyclone. Under the effect of the feed pressure, a vortex is created within the interior cavity. This vortex tends to place the solid phase flat against the peripheral wall of the cavity. The solid phase then flows towards the underflow part of the hydrocyclone while the liquid phase rises towards the overflow outlet of the hydrocyclone.

A mixture of sand and a small quantity of liquid and sludges is extracted in an underflow in order to be at least partly recycled in order to reintroduce ballast in the method. A mixture of liquid, sludges and a small quantity of ballast is extracted in an overflow.

The implementation of such hydrocyclones enables efficient recovery of ballast so that it can be recycled in the method. Their implementation thus helps reduce ballast consumption as well as its inherent costs.

To ensure efficient separation of the liquid phase and solid phase in the mixture of water, sludges and ballast, this mixture must be introduced into the hydrocyclone under high pressure, generally of the order of two bars. To this end, high-powered pumps need to be used. Such pumps are however energy-hungry devices.

Besides, current hydrocyclones are sensitive to fluctuations in the suspended matter (SM) concentration of the water to be treated. However, the SM load of water to be treated varies greatly over a year. During periods in which the water to be treated has a high SM concentration, the underflow outlet of this hydrocyclone can tend to get ponding. The hydrocyclone then has difficulty discharging the mixture of sludges and ballast in the underflow: this phenomenon is called “clogging”. A part of the sludges and ballast is then discharged in an overflow with the treated water, inducing losses of ballast and a drop in the quality of the treated water.

### 3. GOALS OF THE INVENTION

The invention is aimed especially at providing an efficient solution to at least some of these different problems.

In particular, according to at least one embodiment, it is a goal of the invention to provide a hydrocyclone that shows low sensitivity to fluctuations in the SM concentration of the effluent to be treated.

In particular, it is a goal of the invention, according to at least one embodiment, to provide a hydrocyclone of this kind that has low sensitivity to the clogging phenomenon.

It is another goal of the invention, in at least one embodiment, to provide a hydrocyclone of this kind that induces low energy consumption, at least as compared with the prior-art hydrocyclones.

In particular, according to at least one embodiment, it is a goal of the invention to provide a hydrocyclone that can work efficiently with a low feed pressure, at least as compared with the prior-art hydrocyclones.

It is another goal of the invention, in at least one embodiment, to provide a hydrocyclone of this kind that is reliable and/or robust and/or simple to design.

### 4. SUMMARY OF THE INVENTION

To this end, the invention proposes a hydrocyclone comprising:
a body defining a hollow interior cavity, said hollow interior cavity having a upper portion with a cylindrical section extended by a lower portion with a truncated conical section, the diameter of said truncated conical section diminishing towards the lower part of said body;
an inlet for a mixture of liquids and solids leading into said cylindrical portion;
an underflow outlet for the discharge of said solids essentially separated from said liquid, communicating with the lower end of said interior cavity;
an overflow outlet for the discharge of said liquid essentially separated from said solids, communicating with the upper end of said interior cavity;
   wherein said underflow outlet extends from the lower end of said lower portion of truncated conical section and has a truncated conical section, the diameter of which increases towards the lower part of said hydrocyclone.

Thus, according to this aspect of the invention, the implementing of an underflow outlet with a truncated conical section, the diameter of which widens towards the bottom of the hydrocyclone, helps preserve the whirling motion of the fluid.

This helps foster the separation of the liquid and solid phases within the hydrocyclone and limits the phenomenon of congestion of the underflow outlet of the hydrocyclone. A hydrocyclone according to the invention is thus less sensitive to variations in SM concentration of the effluent to be treated.

This also reduces the feed pressure while preserving a high level of separation of the liquid phase and the solid phase in a mixture. Thus, the energy consumption is reduced along with the cost inherent in the implementing of liquid/solid separation by hydrocycloning.

According to one variant, the contour of said underflow outlet comprises at least one helical groove, the winding sense of which is identical to the winding sense (or circulation sense) of the liquid within said interior cavity.

The implementing of such a groove sustains the rotation of the fluid in the lower part of the hydrocyclone. This helps prevent the congestion of the underflow outlet of the hydrocyclone and helps make it less sensitive to variations in SM concentration of the fluid to be treated.

According to one variant, said at least one groove is extended partly on the contour of said lower portion of said interior cavity.

This also sustains the rotation of the fluid in the lower part of the hydrocyclone and plays a part in preventing the congestion of the underflow outlet of the hydrocyclone and in making it less sensitive to variations in SM concentration of the effluent to be treated.

According to one variant, said helical groove forms a hollow.

This ensures efficient guiding of fluid within the hydrocyclone. In one variant, the groove could also form a protruding feature within the interior cavity.

According to one variant, the length of said underflow outlet is greater than three times the diameter of the junction between the truncated conical lower portion of the interior cavity and the underflow outlet of the hydrocyclone.

The length of said underflow will be preferably smaller than or equal to ten times the diameter of the junction between the truncated conical lower portion of the interior cavity and the underflow of the hydrocyclone.

A shorter length would limit the effect anticipated by the implementing of the truncated conical underflow outlet, namely improving the liquid/solid separation and making the hydrocyclone less sensitive to variations in SM concentration of the effluent to be treated while at the same time reducing the feed pressure. A length that is far too great would nevertheless lead to a major head loss.

According to one variant, the angle a of the truncated conical section of the underflow outlet relative to its axis of revolution ranges from 10° to 25°.

According to one variant said overflow outlet comprises a truncated conical tubing that extends in the prolongation of said cylindrical portion and has a diameter increasing in the direction of the upper part of said hydrocyclone.

This reduces the feed pressure and sustains the rotation of the fluid within the hydrocyclone.

According to one variant, said truncated conical tubing comprises an inlet that communicates with said interior cavity and an outlet that leads into a peripheral housing made in said body, said overflow outlet furthermore comprising a discharge tubing that extends laterally to said body, said discharge tubing comprising an inlet that communicates with said peripheral housing and an outlet that leads outside said body.

According to this variant, the overflow outlet of the hydrocyclone is of the spill-over type. Indeed, the liquid phase coming from the interior cavity spills over into the peripheral housing constituting a collecting box or case and flows from this box through the lateral discharge tubing. This preserves the anisotropy and hence the rotation of the spill-over at the overflow. The sludges have an anisotropic flow, i.e. this flow is different (in sense and speed) according to the location of the hydrocyclone where this flow is measured. This results especially from the rotational motion of the sludges inside the hydrocyclone and the nature of the sludges (layers that are not perfectly homogeneous). If the discharge unit were to be different from a spill-over (for example a conduit) then the flow would be forced and would apply heavy stress to the vortex which it is sought to maintain. The spill-over box (collecting box of spill-over) typetherefore makes it possible not to apply stress to the flow.

According to one variant, the angle β of the truncated conical tubing of the overflow outlet relative to its axis of revolution ranges from 10° to 30°.

This makes it possible to obtain a low head loss for the overflow while maintaining the rotational motion.

According to one variant, said inlet comprises an inlet tubing that extends along a spiral about the longitudinal axis of said body.

This increases the speed of entry of the mixture into the interior cavity and increases the centrifugal effect. Conversely, for an equivalent level of centrifugal effect, the flow rate and the feed pressure can be reduced.

According to one variant, said inlet tubing extends along said spiral on a length of ¼ to ¾ of one turn around said body.

This gives a high level of acceleration to the speed of the liquid/solid mixture and increases the centrifugal effect inside the hydrocyclone

According to one variant, said inlet tubing extends inclinedly towards the bottom of said body.

This orients the mixture towards the underflow as soon as it enters the hydrocyclone. Thus, the circulation of solids towards the lower part of the hydrocyclone is favored, and this reduces the feed pressure without harming the process of liquid/liquid separation.

According to one variant, the angle of tilt of said inlet tubing relative to a transversal axis of said body is smaller than or equal to 30°.

According to one variant, the connection of said inlet tubing to said cylindrical portion of said interior cavity is made tangentially.

This enables the mixture to be placed against the peripheral wall of the interior cavity as soon as it enters the hydrocyclone, improves the liquid/solid separation and reduces the feed pressure.

According to one variant, the section of said inlet tubing diminishes gradually towards said cylindrical portion.

This accelerates the flow of the mixture and plays a role in placing the mixture against the peripheral wall of the interior cavity as soon as it enters the hydrocyclone, improving the liquid/solid separation and reducing the feed pressure.

According to one variant, the greatest section of said inlet tubing ranges from 30% to 50% of the section of said cylindrical portion and the smallest section of said inlet tubing ranges from 20% to 30% of the section of said cylindrical portion.

According to one variant, said inlet tubing has a circular section, the connection of said inlet tubing to said cylindrical portion of said interior cavity being made elliptically.

This also plays a role in placing the mixture against the peripheral wall of the interior cavity as soon as it enters the hydrocyclone, improving the liquid/solid separation and reducing the feed pressure.

According to one variant, the ratio between the small radius and the big radius of said elliptically shaped connection ranges from 1 to 2.

According to one variant, the passage from the circular section of said inlet tubing to the elliptical shape of the connection of this tubing with said cylindrical portion of the interior cavity is done gradually.

This reduces the feed pressure of the hydrocyclone.

According to one variant, the upper contour of said cylindrical portion of said interior cavity extends helically with a winding sense identical to the sense of circulation of liquid within said interior cavity.

This sustains the rotation of the fluid as soon as it enters the hydrocyclone, orients the flow towards the underflow outlet and eliminates the dead volume at the top of the cylindrical portion, and thus favors the separation of the liquid and solid phases inside the hydrocyclone and limits the phenomenon of congestion of the underflow outlet of the hydrocyclone. The hydrocyclone is thus less sensitive to the variations in SM concentration of the effluent to be treated. This also makes it possible to reduce the feed pressure of the hydrocyclone.

According to one variant, said upper contour of said cylindrical portion of said interior cavity extends helically from the top to the bottom of the elliptically shaped connection.

This maximizes the effects of the use of the upper contour of the helix-shaped of the interior cavity.

According to one variant, said hydrocyclone comprises means for injecting service water into said interior cavity at the junction between said lower portion with truncated conical section and said underflow outlet.

Such injection means can act as a fuse if, in an extreme case, the hydrocyclone were to be blocked.

### 5. LIST OF FIGURES

Other features and advantages of the invention shall appear from the following description, given by way of a simple illustratory and non-exhaustive example and from the appended drawings, of which:

FIG. 1 illustrates a front view of a hydrocyclone according to the invention;

FIG. 2 illustrates a view in section along a plane passing through the longitudinal axis of the hydrocyclone and the axis of the discharge tubing of a hydrocyclone according to the invention;

FIG. 3 illustrates a partial schematic view of the inner contour of the inlet tubing and of the upper portion with cylindrical section according to the invention;

FIG. 4 illustrates a schematic top view of the inlet tubing and of the upper portion with cylindrical section of a hydrocyclone according to the invention;

FIG. 5 illustrates a top view of a hydrocyclone according to the invention, the upper part of which has been removed;

FIG. 6 illustrates a transparence side view of the underflow outlet of a hydrocyclone according to the invention;

FIG. 7 illustrates a front view of a variant of a hydrocyclone according to the invention, the inlet tube system of which is tilted.

### 6. DESCRIPTION OF A PARTICULAR EMBODIMENT

### 6.1. Architecture

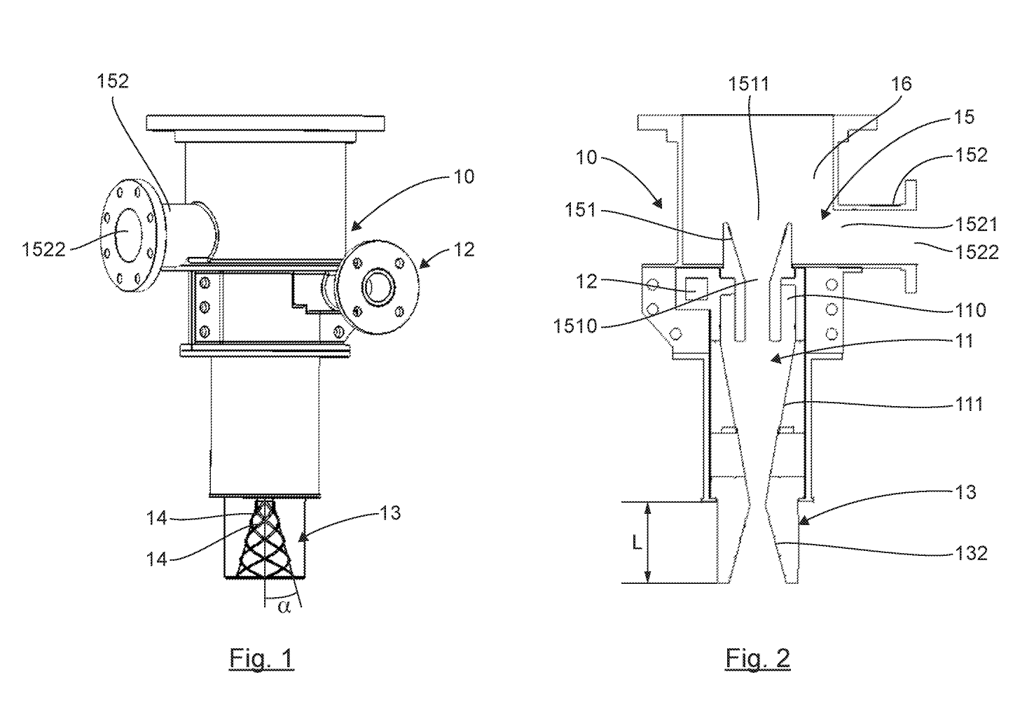

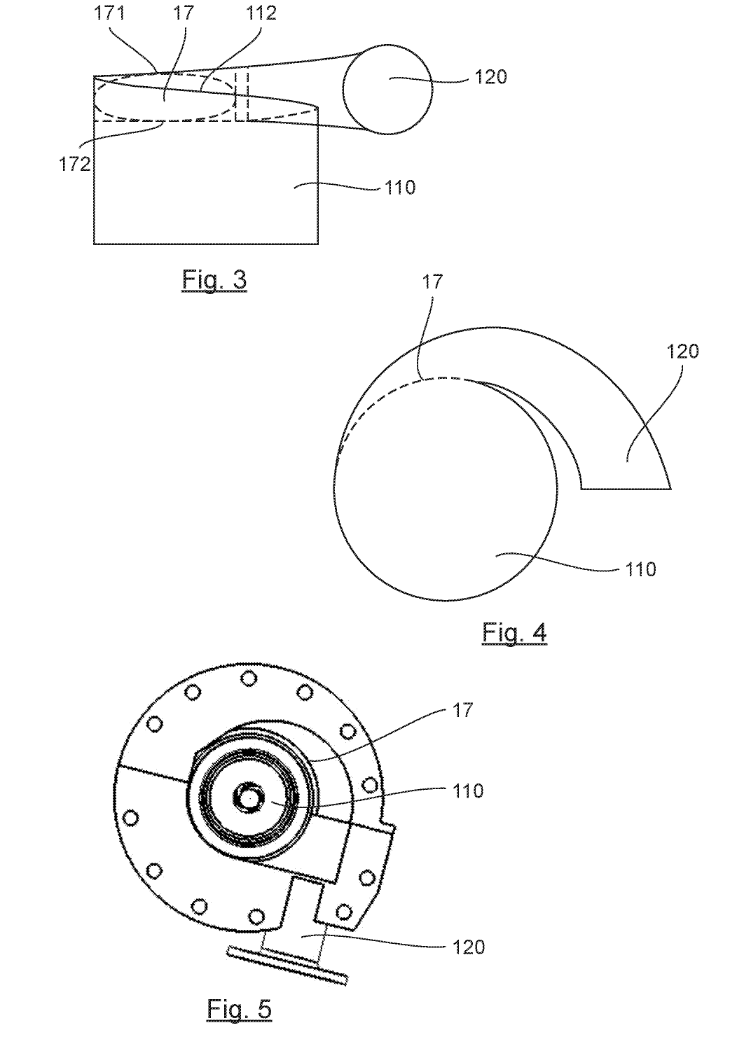

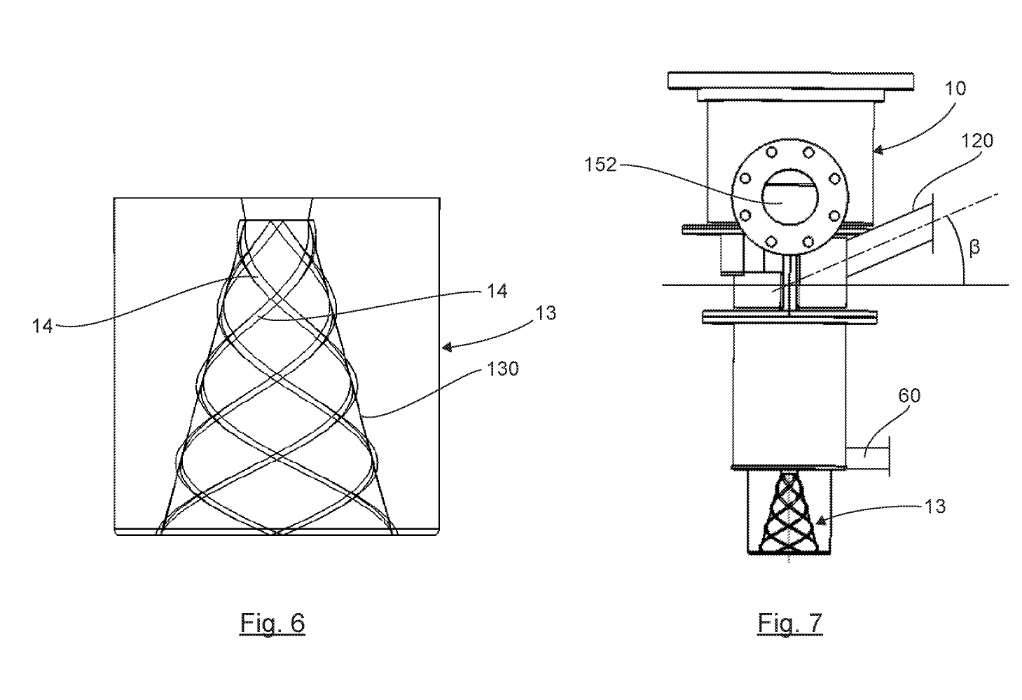

Referring to FIGS. 1 to 7, we present an example of a hydrocyclone according to the invention.

Thus, as represented in these figures, such a hydrocyclone comprises a body 10 extending along a longitudinal axis. This body 10 comprises a hollow interior cavity 11.

This hollow interior cavity 11 comprises:
an upper portion 110 with a cylindrical section, and
a lower portion 11 with a truncated conical section, this portion with a truncated conical section being made in the extension of the cylindrical section towards the bottom of the hydrocyclone.

The truncated conical section herein is the truncated portion of a cone of revolution. Its diameter tends to diminish towards the bottom of the hydrocyclone.

This hydrocyclone comprises an inlet 12 for a mixture of liquid and solid, for example a mixture of water, settled sludges and ballast.

This inlet 12 has an inlet tubing 120. This inlet tuning 120 has a circular section. The axis of this inlet tubing 120 is tilted downwards relative to a transversal axis of the body of the hydrocyclone, i.e. relative to an axis orthogonal to the longitudinal axis of the body 10, by an angle β smaller than or equal to 30° (cf. FIG. 7). The inlet of this inlet tubing 120 is thus higher than its outlet. In one variant, it can be that this inlet tubing is not tilted (cf. FIGS. 1 and 2). In this case, it will extend along an axis orthogonal to the longitudinal axis of the body 10.

The inlet tubing 120 forms a spiral about the longitudinal axis of the body 10. This spiral extends over ¼ to ¾ of the periphery of the body 10.

The connection 17 of the inlet tubing 120 with the cylindrical portion 110 of the interior cavity 10 is done tangentially.

The section of the inlet tubing 120 diminishes gradually towards the cylindrical portion 110.

The greatest section of the inlet tubing, i.e. the section of its inlet, ranges from 30% to 50% of the section of the cylindrical portion 110 and the smallest section of the inlet tubing 120 ranges from 20% to 30% of the section of the cylindrical portion 110.

The inlet tubing 120 has a circular section. Its connection to the cylindrical portion 110 of the interior cavity 10 is preferably done elliptically. In other words, the connection 17 has the shape of an ellipse.

The ratio between the small radius and the large radius of the elliptically shaped connection 17 between the inlet tubing 120 and the cylindrical portion 110 ranges from 1 to 2.

The passage from the circular section of the inlet tubing 120 to the elliptical shape of the connection of this inlet tubing to the cylindrical portion 110 of the interior cavity 11 is done gradually.

The upper contour 112 of the cylindrical portion 110 of the interior cavity 11 extends helically with a winding sense identical to the sense of circulation of the liquid inside the interior cavity 11, and does so preferably from the top 171 to the bottom 172 of the elliptical shaped connection 17 between the inlet tubing 120 and the cylindrical portion 110.

The hydrocyclone comprises an underflow outlet 13 for the discharge of solids essentially separated from the liquid of the mixture introduced into the hydrocyclone via the inlet tubing 120. This underflow 13 communicates with the lower end of the interior cavity 11, more specifically with the lower end of the truncated conical portion 111.

The underflow outlet 13 extends from the lower end of the lower truncated conical section portion 111. It has a truncated conical section 130, the diameter of which increases towards the lower part of the hydrocyclone. This truncated conical portion is in this embodiment a truncated cone of revolution. It opens into the exterior of the body 10.

The length L of the underflow 13 is greater than three times the diameter of the junction between the lower truncated conical portion of the interior cavity of the underflow outlet of the hydrocyclone. The angle α of the truncated conical portion 130 of the underflow outlet 13 relative to its longitudinal axis or axis of revolution ranges from 10° to 25°.

The underflow outlet 13 comprises at least one helical groove 14, the winding sense of which is identical to the sense of circulation of the liquid inside the interior cavity 11, i.e. of the mixture of liquid composed of solids and liquid that are introduced inside of the hydrocyclone. The number of grooves would preferably be an even number. This number could for example be equal to two or to four. The grooves will be distributed uniformly on the periphery of the truncated conical section 130 of the underflow outlet 13. The groove or grooves will preferably be hollowed features made on the surface of the truncated conical section 30 of the underflow outlet 13. As an alternative, these features could be ridges on a surface of the truncated conical section of the underflow outlet, i.e. they could form an extra thickness inside the underflow outlet 13.

The groove or grooves 14 extend partly on the contour of the lower portion of the interior cavity.

The hydrocyclone comprises an overflow outlet 15 for the discharge of liquid essentially separated from the solids of the mixture introduced into the hydrocyclone via the inlet tubing. This overflow outlet communicates with the upper end of the interior cavity 11, more specifically with the upper end of the cylindrical upper portion 110.

The overflow outlet 15 comprises a truncated conical tubing 151 which extends in the prolongation of the cylindrical portion 110. Its diameter increases towards the upper portion of the hydrocyclone. In this embodiment, it constitutes a truncated cone of revolution.

The truncated conical tubing 151 of the overflow outlet 15 comprises an inlet 1510 which communicates with the interior cavity 11, in this case with its upper cylindrical portion 110 and an outlet 1511 which leads into a peripheral housing 16 made in the body 11. This peripheral housing is a collecting box. The overflow outlet 15 furthermore comprises a discharge tubing 152 which extends laterally to the body along an axis essentially orthogonal to the longitudinal axis of the body 10. This lateral discharge tubing 152 comprises an inlet 1521 which communicates with the peripheral housing 16 and an outlet 1522 which leads out of the body 10. The overflow outlet 15 is a spill-over outlet inasmuch as the liquid coming from the truncated conical tubing 151 spills over or runs off into the peripheral housing 16 and gets shed into the discharge tubing system 152.

The angle of the truncated conical tubing 151 of the overflow outlet relative to its longitudinal axis or axis of revolution ranges from 10° to 30°.

In one variant, the hydrocyclone comprises means for injecting service water into the interior cavity, at the junction between the lower truncated conical portion and the underflow outlet. These injection means can for example include a service water injection pipe 60.

The fact of injecting service water at the junction between the truncated conical lower portion and the underflow outlet can act as a fuse if, in an extreme case, the hydrocyclone were to get clogged, and can thus enable it to be unclogged.

### 6.2. Operation

A hydrocyclone according to the invention can conventionally be implemented to carry out the separation of a liquid phase and a solid phase of a mixture such as for example a mixture of water and settled or sedimentation sludges containing ballast.

To this end, such a mixture is introduced inside the hydrocyclone via the inlet tubing 120 under low pressure, preferably ranging from 0.3 to 1.5 bars. Owing to the spiral shape of this inlet tubing, the fluid accelerates inside the inlet tubing and the centrifugal effect increases. On the contrary, for a same centrifugal effect, the feed flow rate and the head loss can be lower. It is thus possible to reduce the feed pressure.

Since the section of the inlet tubing diminishes, the fluid accelerates, thus producing the same effect as the one mentioned in the above paragraph. The centrifugal effect tends to place the solids flat against the external wall.

The inlet tubing is tilted towards the underflow outlet of the hydrocyclone. The fluid is thus oriented as soon as it enters the hydrocyclone in the sense of its flow inside the interior cavity 11 of the hydrocyclone. This also diminishes the feed pressure by avoiding the “dead volume” at the top of the interior cavity that would trap solid matter and harm the quality of the separation.

The fluid penetrates the cylindrical upper portion 110 by passing through the elliptically shaped connection between the inlet tubing 120 and the cylindrical upper section. In addition, this connection is made tangentially to the inner peripheral contour of the cylindrical upper portion 110. Owing to the geometrical characteristics of this connection, the solids as well as the liquid remain placed flat near the inner wall of the lower cavity 11 as soon as they enter this cavity.

The fluid flows along the upper contour 112 of the cylindrical portion 110 of the interior cavity 11 which extends helically with a winding sense identical to the sense of circulation of the liquid inside the interior cavity 11, from the top to the bottom of the elliptically shaped connection between the inlet tubing 120 and the cylindrical portion 110. This makes it possible to avoid the dead zones in the upper region of the cylindrical upper portion 110, convey the fluid that has to circulate towards the underflow outlet of the hydrocyclone and reduce the feed pressure.

The fluid continues to flow inside the interior cavity 11 in passing into the truncated conical lower portion 111. The solid phase then flows towards the underflow outlet 13 of the hydrocyclone while the liquid phase rises up to the overflow outlet 15 of the hydrocyclone.

The solid phase flows from the truncated conical lower section 111 towards the underflow 13. It flows along grooves 14 which extend on the peripheral contour of the lower region of the truncated conical section 111. The use of grooves 14 in this zone sustains the rotation of the fluid and reduces the sensitivity of the hydrocyclone to the SM load of the mixture introduced into it.

The solid part of the fluid flows inside the truncated conical section 130 of the underflow outlet 13. The use of an underflow with truncated conical section, the diameter of which widens towards the bottom, makes it possible to prevent induced flows, thus maintaining the rotation of the fluid inside the hydrocyclone. This diminishes the feed pressure.

The grooving 14 inside the truncated conical section 130 sustains the rotation of the fluid and consequently makes the hydrocyclone less sensitive to the variation of the SM load of the mixture introduced into it.

The liquid phase rises to the interior of the interior cavity 11 in passing from the truncated conical lower portion 111 to the cylindrical upper portion 110 then to the truncated conical tubing 151 of the overflow outlet 15.

The use of the truncated conical tubing 151, the diameter of which widens towards the top, preserves the anisotropy of the overflow. This maintains the rotation of the fluid. It also diminishes the feed pressure.

The liquid then runs off from the upper part of the truncated conical tubing 151 into the interior of the peripheral housing 16. It then flows from the peripheral housing 16 to the interior of the discharge tubing 152.

Since the liquid phase spills over from the truncated conical tubing 151 into the interior of the peripheral housing 16, it maintains a low and constant height of water in the overflow outlet, and thus does not constrain the underflow.

### 6.3. Advantages

The technique according to the invention facilitates the rotation of the fluid inside the hydrocyclone and preserves this rotation by the implementation, independently or in combination, of:
the inclined inlet tubing;
the helical shape of the upper surface of the cylindrical upper portion;
the truncated section of the underflow;
of the truncated tubing of the overflow;
the discharge of the liquid phase by spill-over;
of the grooving inside the truncated conical section of the underflow;
the grooving in the lower zone of the truncated conical lower portion of the interior cavity.

All this takes part in favoring the separation of the liquid and solid phases inside the hydrocyclone and limits the phenomenon of congestion of the underflow of the hydrocyclone.

The technique according to the invention reduces the feed pressure of the hydrocyclone by the implementation of the following independently or in combination of:
the spiral-shaped inlet tubing;
the elliptically shaped and tangential connection between the inlet tubing and the cylindrical upper portion;
the reduction of the section of the inlet tubing towards the interior cavity;
the gradual change of shape from circular to elliptical between the inlet tubing and its connection to the interior cavity;
the tilt of the inlet tubing;
the helical shape of the upper surface of the cylindrical upper portion;
the truncated conical section of the underflow outlet;
the truncated conical tubing of the overflow outlet;
the discharge of the liquid phase by spill-over;

The technique according to the invention reduces the sensitivity of the hydrocyclone to changes in SM load of the mixture introduced inside it and thus limits the phenomenon of congestion of the underflow by the implementation, independently or in combination, of:
the grooving inside the truncated conical section of the underflow outlet;
the grooving in the lower zone of the truncated conical lower portion of the interior cavity;
the discharge of the liquid phase by spill-over.

1-21. (canceled)

22. A hydrocylone for receiving a mixture containing suspended solids and separating the mixture into a liquid phase and a solid phase, the hydrocyclone comprising:
a body having an interior cavity;
an inlet disposed on the body for receiving the mixture;
a liquid phase outlet disposed on the body for directing the separated liquid phase from the hydrocyclone;
the interior cavity including a cylindrical section disposed intermediately in the body for receiving the mixture from the inlet and wherein the inlet and cylindrical section are configured such that the mixture upon introduction swirls around the cylindrical section;
the interior cavity further including an upper section for receiving the liquid phase separated from the mixture;
a first truncated conical section extending upwardly from the cylindrical section for directing the separated liquid phase from the cylindrical section into the upper section;
wherein the first truncated conical section includes a diameter that generally increases towards the top of the hydrocyclone;
the interior cavity further including a second truncated conical section disposed below and communicatively connected to the cylindrical section for directing the solid phase separated from the mixture downwardly from the cylindrical section towards the bottom of the hydrocyclone;
the second truncated conical section having a diameter that decreases towards the bottom;
an underflow outlet disposed below the second truncated conical section for receiving the separated solid phase from the second truncated conical section and directing the separated solid phase towards the bottom of the hydrocyclone;
the underflow outlet includes a third truncated conical section that includes a diameter that generally increases towards the bottom of the hydrocyclone; and
the third truncated conical section includes an inner surface and wherein there is formed one or more helical grooves or ridges that wind around the inner surface and wherein the helical grooves or ridges sustain the rotation of the solid phase and reduce the sensitivity of the hydrocyclone to fluctuations in suspended solids concentration in the mixture introduced into the hydrocyclone.

23. Hydrocyclone comprising:
a body defining a hollow interior cavity, said hollow interior cavity having an upper portion with a cylindrical section extended by a lower portion with a truncated conical section, the diameter of said truncated conical section diminishing towards the lower part of said body;
an inlet for a mixture of liquids and solids leading into said cylindrical portion;
an underflow outlet for the discharge of said solids essentially separated from said liquid, communicating with the lower end of said interior cavity;
an overflow outlet for the discharge of said liquid essentially separated from said solids, communicating with the upper end of said interior cavity;
wherein said underflow outlet extends from the lower end of said lower portion of truncated conical section and has a truncated conical section, the diameter of which increases towards the lower part of said hydrocyclone,
characterized in that the contour of said underflow outlet comprises at least one helical groove, of which the winding sense is identical to the winding sense of the liquid within said interior cavity.

24. Hydrocyclone according to claim 23, wherein said at least one groove is extended partly on the contour of said lower portion of said interior cavity.

25. Hydrocyclone according to claim 23, wherein said helical groove forms a hollow.

26. Hydrocyclone according to claim 23, wherein the length of said underflow outlet is greater than three times the diameter of the junction between the truncated conical lower portion of the interior cavity and the underflow outlet of the hydrocyclone.

27. Hydrocyclone according to claim 23, wherein the angle a of the truncated conical section of the underflow outlet relative to its axis of revolution ranges from 10° to 25°.

28. Hydrocyclone according to claim 23, wherein said overflow outlet comprises a truncated conical tubing that extends in the prolongation of said cylindrical portion and that has a diameter increasing in the direction of the upper part of said hydrocyclone.

29. Hydrocyclone according to claim 28, wherein said truncated conical tubing comprises an inlet that communicates with said interior cavity and an outlet that leads into a peripheral housing made in said body, said overflow outlet furthermore comprising a discharge tubing that extends laterally to said body, said discharge tubing comprising an inlet that communicates with said peripheral housing and an outlet that leads outside said body.

30. Hydrocyclone according to claim 28, wherein the angle of the truncated conical tubing of the overflow outlet relative to its axis of revolution ranges from 10° to 30°.

31. Hydrocyclone according to claim 23, wherein said inlet comprises an inlet tubing that extends in a spiral about the longitudinal axis of said body.

32. Hydrocyclone according to claim 31, wherein said inlet tubing extends along said spiral on a length of ¼ to ¾ of one turn around said body.

33. Hydrocyclone according to claim 31, wherein said inlet tubing extends inclinedly towards the bottom of said body.

34. Hydrocyclone according to claim 33, wherein the angle of tilt β of said inlet tubing relative to a transversal axis of said body is smaller than or equal to 30°.

35. Hydrocyclone according to claim 31, wherein the connection of said inlet tubing to said cylindrical portion of said interior cavity is made tangentially.

36. Hydrocyclone according to claim 31, wherein the section of said inlet tubing diminishes gradually towards said cylindrical portion.

37. Hydrocyclone according to claim 36, wherein the greatest section of said inlet tubing ranges from 30% to 50% of the section of said cylindrical portion and the smallest section of said inlet tubing ranges from 20% to 30% of the section of said cylindrical portion.

38. Hydrocyclone according to claim 31 wherein said inlet tubing has a circular section, the connection of said inlet tubing to said cylindrical portion of said interior cavity being made elliptically.

39. Hydrocyclone according to claim 38, wherein the ratio between the small radius and the big radius of said elliptically shaped connection ranges from 1 to 2.

40. Hydrocyclone according to claim 36, wherein the passage from the circular section of said inlet tubing to the elliptical shape of the connection of this tubing with said cylindrical portion of the interior cavity is done gradually.

41. Hydrocyclone according to claim 31 wherein the upper contour of said cylindrical portion of said interior cavity extends helically with a winding sense identical to the sense of circulation of the liquid within said interior cavity.

42. Hydrocyclone according to claim 41, wherein said upper contour of said cylindrical portion of said interior cavity extends helically from the top to the bottom of the elliptically shaped connection.

43. Hydrocyclone according to claim 23, comprising means for injecting service water into said interior cavity, at the junction between said lower portion with truncated conical section and said underflow outlet.
